(19) United States
(12) Patent Application Publication
(10) Pub. No.: US 2011/0302108 A1
(43) Pub. Date: Dec. 8, 2011

(54) TRANSFERRING ELECTRIC ENERGY BETWEEN AN ELECTRIC VEHICLE AND A POWER DISTRIBUTION GRID

(75) Inventor: Thomas Werner, Rednitzhembach (DE)

(73) Assignee: SIEMENS AKTIENGESELLSCHAFT, MUENCHEN (DE)

(21) Appl. No.: 13/202,201

(22) PCT Filed: Feb. 18, 2009
(86) PCT No.: PCT/EP2009/001301

§ 371 Date: Aug. 30, 2011

(51) Int. Cl. G06F 1/26; G06F 17/00

(52) U.S. Cl. 705/412; 700/297

(57) ABSTRACT

In order to be able to perform the transfer of electric energy between an electric energy storage device of an electric car and a connection point of an electrical power distribution grid using relatively less effort, particularly with regard to the technical construction of the connection point, the novel method controls the transfer of electric energy between the electric energy storage device of a vehicle and a connection point of an electrical power distribution grid. An electrical connection is produced between the electric energy storage device and the connection point, a communication connection is produced between a communication device associated with the vehicle and a communication service provider, the electric energy is transferred between the electric energy storage device and the connection point during the period of time that the communication connection exists at constant average electrical power, and the transfer of the electric energy and the communication connection are terminated at the same time.

The invention relates to a method for transferring electric energy between an electric energy storage device of a vehicle and a connection point of an electric energy distribution grid, and to a corresponding device for controlling the transfer of the electric energy.

Vehicles with electric drives, referred to as “electric cars”, have recently been the focus for increasing attention. There are a number of reasons for this. On the one hand, many large and reputable power supply companies see electric cars as a potential new market for electric energy. Furthermore, electric cars are significantly more environmentally friendly than conventional cars operated with internal combustion engines if correspondingly environmentally friendly technologies are used to generate the electric energy. In addition, the current prices for electricity mean that the average power costs per kilometer traveled are significantly lower with a conventional internal combustion engine drive. Finally, the power stores of the electric cars can be integrated as micro power stores into electrical grids and therefore contribute to compensating the often fluctuating feed rates of electric energy which is generated with regenerative technologies.

At present, vehicle manufacturers are already marketing what are referred to as “hybrid vehicles”, that is to say vehicles with an internal combustion engine drive and an assisting electric drive. The first pure electric cars, which are comparable with contemporary conventional vehicles, are expected to go into series production in 2010. The storage technology which is currently available for electric energy storage devices permits ranges of 100 to 200 km for the purely electric traveling mode.

Because the charging process of an electric energy storage device requires a certain amount of time, consideration is now also being given to providing charging facilities for electric energy storage devices of electric cars in public spaces, for example in parking lots or in multistory car parks, so that the electric energy storage devices can be charged during the immobilization times of the electric cars. For this purpose, an electrical connection has to be made to an electric energy distribution grid via which the electric energy storage device can be charged.

From the point of view of the vehicle driver, multiple requirements have to be met here. Firstly, the charging device must ensure that the filling levels of the electric energy storage device which are aimed at by the vehicle driver can actually be achieved. In addition, the charging process may take place only when the costs for the electric energy are also accepted by the vehicle driver. Furthermore, accurate billing for the transferred electric energy has to be carried out.

When the vehicle is connected to an electric energy distribution grid and the electric energy storage device is charged, from the point of view of the customer, that is to say the vehicle driver, in theory two contracts come into force in a liberalized power market: on the one hand a contract with a grid operator for the use of the electric energy distribution grid on which the connection point for the vehicle is arranged, and on the other hand a contract with a provider of electric energy (“power provider”, for example an operator of a power plant) for the provision of the electric energy. While the grid operator is already predefined by the position of the connection point, the power provider can usually be selected on a virtually free basis. In general, the costs for the services provided by the grid operator and by the power provider are dependent on the quantity of electric energy which the customer draws from the power distribution grid, with the result that both the grid operator and the power provider receive appropriate remuneration. For this reason, the consumption, that is to say the quantity of electric energy transferred, has to be measured and assigned to the grid operator and the power provider.

In the case of stationary consumers, such as, for example, in apartment buildings and commercial premises, the numerical values of the electric energy consumption are at present passed on from the grid operator to the power provider. For this purpose, the operators of measuring facilities maintain complex measuring and information systems which ensure that the electrical consumption is measured and, if appropriate, the necessary electronic exchange of data is carried out with the participants in the market, that is to say in particular the grid operator and the provider of electric energy. In these systems, all the contractual relationships between the end users of electric energy and the grid operator and the power provider are modeled. This is possible because, on the one hand, the assignment of the end user to a specific grid operator is inevitably predefined by his fixed location in a specific power distribution grid and, on the other hand, the number of customer movements, that is to say new customer registrations and customer de-registrations, is comparatively small in the case of a power provider, and all the changes of the relationships between customers and power providers are documented.

It is not possible to transfer this procedure to the measuring of the electric energy consumption during the charging process of electric cars. In theory, all licensed electric cars can be charged at a public connection point for electric energy. All the grid operators would therefore have to know the data of the keepers of all the electric cars in order to be able to apportion the corresponding costs appropriately to those incurring them. This would involve immense information technology costs for the grid operators. Given approximately 47 million passenger cars in Germany alone, the volume of data which would have to be exchanged between power grid operators, power providers and customers would simply be too large. To be precise, for each charging process it would be necessary to register the power distribution grid and the power provider which is supplying the vehicle. Since electric cars are of course mobile, these relationships themselves may change repeatedly within one day.

The invention is therefore based on the object of specifying a method and a device of the type specified at the beginning such that the transfer of the electric energy can be controlled with comparatively little expenditure, in particular in terms of the technical design of the connection point in the electric energy distribution grid.

This object is achieved by means of a method for controlling the transfer of electric energy between an electric energy storage device of a vehicle and a connection point of an electric energy distribution grid, in which an electrical connection is produced between the electric energy storage device of the vehicle and the connection point of the electric energy distribution grid; furthermore, a communication connection is produced between a communication device assigned to the vehicle and a communication service provider. The electric energy is transferred here between the electric energy storage device and the connection point during the period of time for which the communication connection exists, wherein the transfer of electric energy takes place at a constant mean electric energy rating, and the transfer of the electric energy and the communication connection are terminated at the same time.

The particular advantage of the method according to the invention is that apart from the purely electrical connection facility, no further technical devices, in particular no communication devices, have to be provided at the connection point for the electric energy distribution network, which avoids a costly construction of communication infrastructure for the connection points. In the method according to the invention, recourse is in fact made to a communication infrastructure which already has virtually total coverage, and the transfer of electric energy, for example for charging the electric energy storage device, is permitted exclusively during the existence of the communication connection. In the case of an electric energy rating which is constant during the power transfer process at least when averaged over time, the quantity of power which is transferred can in fact very easily be determined from the period of time, known to the communication service provider, for which the communication connection exists, and the mean electric energy rating, which is also known.

One advantageous embodiment of the method according to the invention provides that a power information item, which indicates the mean electric energy rating for the transfer of the electric energy, is transferred via the communication connection.

In this advantageous embodiment, the power transfer process is not limited to a single predefined value of the mean electric energy rating which is the same for all vehicles, but rather an individual mean power value can be specified for each transfer process, which power value can be used to determine the electric energy which is transferred.

Specifically, in this context it is possible to provide that the mean electric energy rating is determined using at least one of the following parameters:
a current charge state of the electric energy storage device;
a desired range of the vehicle;
a predefined time period during which the transfer of the electric energy is to take place.

It is therefore possible, in order to perform non-damaging charging of an electric energy storage device from which comparatively little electric energy has been drawn (the electric energy storage device is still well filled), to carry out, for example, the transfer process at a lower electric energy rating than the transfer process in a virtually completely discharged electric energy storage device, which can be correspondingly charged with a higher electric energy rating. For this reason, the mean electric energy rating for the transfer process can be carried out as a function of the current charge state of the electric energy storage device. The charge state can be detected here by measurement by a control device which is configured to control the transfer process.

In addition, the mean electric energy rating is also dependent on the distance which the vehicle is still to travel (the desired range of the vehicle) and how long the vehicle is expected to be stationary at the connection point of the electric energy supply grid. For example, in the case of a short immobilization time and a desired large range, the electric energy storage device must therefore be charged with a higher mean electric energy rating than, for example, in the case of a relatively long immobilization time. The two last-mentioned parameters can be interrogated from the vehicle driver, for example before the start of the transfer process.

A further advantageous embodiment of the method according to the invention provides that the communication service provider determines billing information at least from the period of time during which the communication connection is maintained and from the mean electric energy rating for the transfer of the electric energy, said billing information indicating the costs for the transferred electric energy.

In this way, the communication service provider can determine the transferred electric energy, for example, within the scope of what is referred to as an “added value service” by measuring the period of time for which the communication connection exists and the known mean electric energy rating, and can determine therefrom the costs for the transferred electric energy for which the vehicle driver is to be billed, and can present a bill to the vehicle driver for the communication connection. Grid operators and power providers can subsequently be remunerated by the communication service provider for the electric energy which has been supplied.

A further advantageous embodiment of the method according to the invention provides that when the communication connection is produced, identification information is transferred to the communication service provider, which identification information comprises an identifier of a grid operator of the power distribution grid and/or an identifier of a selected provider of electric energy.

As a result it is in fact comparatively easily possible to make an assignment of a specific power transfer process to a particular grid operator of the power distribution grid which makes available the connection point for the vehicle, on the one hand, and a selected provider of electric energy, on the other.

Specifically, in this context it is possible to provide that a mobile radio connection is produced as a communication connection, and the identification information and/or power information for indicating the mean electric energy rating is contained in a call number used to produce the mobile radio connection.

In this way, all the information which is necessary for billing for the power transfer process can be defined solely by means of the call number used for the mobile radio connection, with the result that the communication service provider can perform a cost calculation by means of the call number and the duration of the communication connection. Furthermore, given a corresponding structure of the call number, the costs per time unit for maintaining the communication connection can already be defined when the communication connection is produced, with the result that no subsequent calculations have to be carried out.

In this context it is considered particularly advantageous if that identification information which comprises an identifier of the grid operator of the power distribution grid is made available by the connection point for retrieval.

In this case, the connection point can make available, for example by means of a passive wireless transmission technology, for example by means of the RFID (Radio Frequency Identification) technology, retrievable information relating to the grid operator of the power distribution grid in which the specific connection point is located.

A further advantageous embodiment of the method according to the invention provides in this context that before the communication connection is produced by means of the communication device, that identification information which comprises an identifier of the provider of the electric energy is retrieved from a data processing device which makes available identification information from various providers of electric energy.

This makes it possible for the electric energy not to be drawn exclusively from a single provider of electric energy but rather for a selection to be made from a plurality of providers.

Specifically, in this context it is possible to provide that the data processing device makes available, in addition to the identification information for the individual providers of electric energy, respective price information which indicates the prices of the electric energy to be drawn, and the identification information of the provider with the lowest price is selected.

As a result, the respectively cheapest provider of electric energy can be selected for each power transmission process.

A further advantageous embodiment of the method according to the invention consists in the fact that the start and the end of the communication connection are communicated by the communication device to a control device, and the control device permits the electric energy to be transferred exclusively for the period of time between the start and the end of the communication connection.

In this context it is possible for the communication device and the control device to be, for example, components of the same electronic device; however, it is also possible to provide that the communication device is, for example, a cell phone which can transmit signals, in a wire-bound or wireless fashion, to a control device of the vehicle.

The abovementioned object is also achieved by a device for controlling a transfer of electric energy between an electric energy storage device of a vehicle and a connection point of an electric energy supply grid, having a communication device which is configured to produce a communication connection with a communication service provider, and a control device which is configured to permit a transfer of the electric energy between the electric energy storage device and the connection point exclusively for that period of time during which the communication connection is maintained.

The invention will be explained below in more detail with reference to an exemplary embodiment. In the drawings:

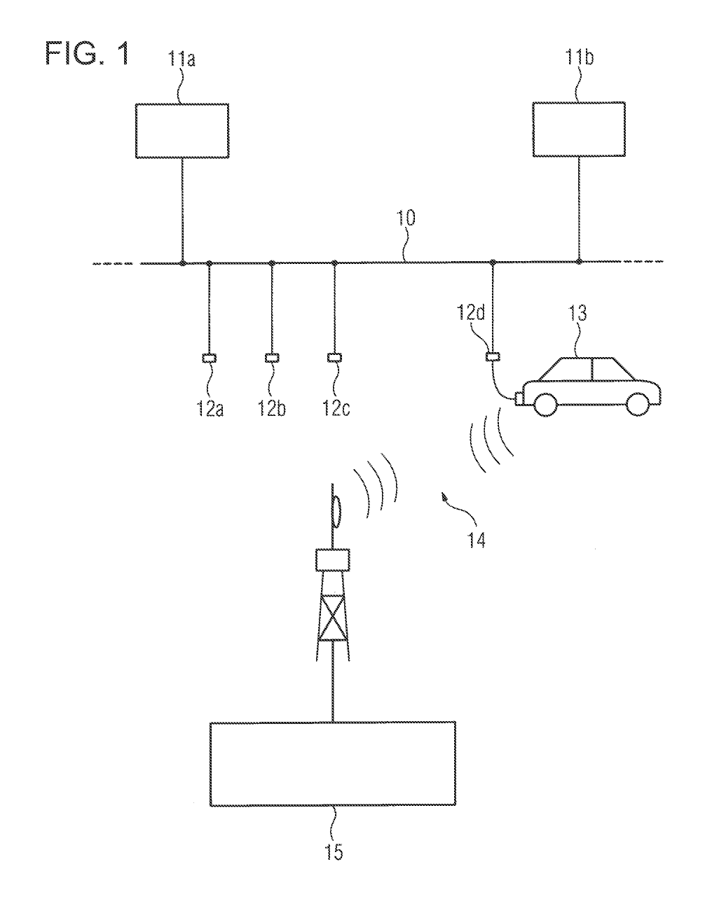

FIG. 1 shows a schematic overview of a system for transferring electric energy between an electric vehicle and an electric energy supply grid, and

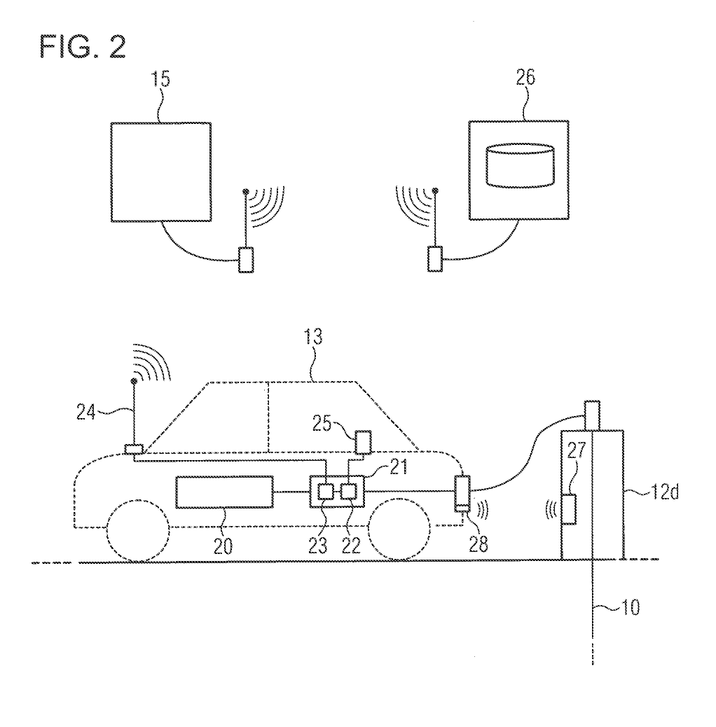

FIG. 2 is a schematic view of an electric vehicle which is connected to a connection point of an electric energy supply grid.

FIG. 1 shows a section 10 of an electric energy supply grid which is otherwise not illustrated in more detail. Power sources 11a and 11b, which can be, for example, power plants for generating electric energy, solar installations or wind power installations, are connected to the section 10 of the electric energy supply grid. The power sources 11a and 11b can be operated here by a single provider or by different providers of electric energy.

Section 10 of the electric energy distribution grid also has connection points 12a, 12b, 12c and 12d with which vehicles having an electric drive, referred to below as electric cars, can be connected for the transfer of electric energy between the connection points 12a to 12d and an electric energy storage device of the electric car. In this context, electric energy can be made available at the connection points 12a to 12d, for example via a galvanic or an inductive coupling. For example, in FIG. 1 an electric car 13, which has an electric energy storage device (not illustrated in FIG. 1), for example an electric accumulator, is connected to the connection point 12d. During the operation of the electric car, the electric energy storage device outputs electric energy to an electric motor of the electric car in order to drive it. For this reason, the electric energy storage device can be charged again in good time before complete discharge. For this purpose, electric cars are usually connected to a domestic electric energy connection. Owing to the limited range which is provided by the respective charge of the electric energy storage device, it is advantageous also to be able to recharge electric cars within a short time at public locations, for example in parking garages or parking lots.

For this purpose, there is provision according to the exemplary embodiment in FIG. 1 that the electric car 13 has a device for controlling the transfer of electric energy, which device is configured such that a transfer of electric energy between the connection point 12d and the electric energy storage device of the electric car 13 is permitted only when a communication connection, such as is merely indicated by way of example in FIG. 1 by the wireless mobile radio connection 14, is produced at the same time to a communication service provider 15.

The communication connection can be present here in different ways, for example as a mobile radio connection, as a wireless network connection, for example at what is referred to as a WLAN hotspot or, if the communication infrastructure for this is present, also as a wire-bound communication connection.

For the following statements, it should be assumed that the communication connection is produced as a mobile radio connection between a communication device which is assigned to the electric car and the communication service provider 15.

The communication device can be either a communication terminal, such as a cell phone of the vehicle driver, which is connected to a corresponding control device of the electric car, or a communication module which is permanently integrated into the electric car, for example what is referred to as a GSM module. When a cell phone is used as a communication device, it can be controlled by a wire-bound or wireless data connection (using, for example, what is referred to as Bluetooth technology) to a control device of the electric car, which control device controls the power transfer process. For the following statements it should be assumed merely by way of example that the communication device is a communication module which is permanently installed in the electric car.

In the text which follows, an exemplary embodiment of a method for controlling the transfer of power between an electric energy distribution grid and an electric car will be explained in more detail with reference to FIGS. 1 and 2. In this respect, FIG. 2 shows a more detailed view, compared to FIG. 1, of the electric car 13 which is connected to the connection point 12d.

As is clear in FIG. 2, the electric car 13 has an electric energy storage device 20 and a device 21 for controlling the transfer of electric energy between the electric energy storage device 20 and the connection point 12d of the section 10 of the power distribution grid shown only in outline in FIG. 2. The device 21 comprises a control device 22 and a communication device 23. Data can be exchanged between the control device 22 and the communication device 23. The communication device is additionally connected to an antenna 24 for the wireless transmission and reception of signals. The control device 22 is also connected to a user input device 25 by means of which information can be displayed to the vehicle driver and inputs can be made by said driver. The user input device can be integrated, for example, in a dashboard of the electric car.

A wireless mobile radio connection to the communication service provider 15 can be produced via the antenna 24 by means of the communication device 23. In addition, it is also, optionally, possible to produce a mobile radio connection to a data processing device 26, for example a data server, which connection makes available information about various providers of electric energy (“power providers”), in particular an identifier of the power provider and price information about the current price of electric energy which is to be drawn.

With the system illustrated in FIGS. 1 and 2, electric energy can be transmitted between the electric energy storage device 20 of the electric car 13 and the connection point 12d in such a way that the transferred electric energy can be measured, and therefore billing can be carried out for the costs of the electric energy without further technical expenditure on the connection point 12d.

Communication service providers, in particular telecommunication service providers, operate call numbers for added value services (for example 0180 . . . /0900 . . . —numbers) on behalf of various service providers. Billing for these added value services is generally time-dependent by way of the contractual relationship between the communication service provider and the end customer. If it is assumed that, at least when averaged over time, the electric energy storage device 20 is charged with a constant electric energy rating, the transmitted electric energy can be calculated from the product of the power and of the duration of the transfer. It is therefore sufficient if the time within which the electric energy is transferred is determined.

For this purpose, a mobile radio connection to an added value service number is produced chronologically in parallel with the power transfer process in order to measure the period of time within which electric energy is drawn from the power distribution grid. For this purpose, identification information and/or identification numbers, which identify the grid operator and the power provider, have to be transferred within the course of the communication connection. For example, the grid operator and the power provider can likewise be identified by the selection of the corresponding call number for setting up the mobile radio communication.

For this purpose, the communication service provider firstly sets up various call numbers for added value services for billing for the electric energy. These numbers can be structured, for example, according to the following pattern:
Call number: VVVV/LL NNN SSS.

With the following meaning:
VVVV: code for the added value service, for example 0180,
LL: identification number for the charging power (for example 06 for 0.6 kW),
NNN: identification number of the grid operator, and
SSS: identification number of the power provider.

The control device 22 which is installed in the electric car 13 selects a power provider and therefore defines the identification numbers “SSS”. For this purpose, the control device 22 can, for example, set up a connection to the data processing device 26 via the communication device 23, and can interrogate information about various power providers from said data processing device 26. This information comprises, in particular, the identification number of the respective power provider and price information about the price which the power provider is currently charging for its electric energy. The control device subsequently selects that power provider which makes available its electric energy at the lowest price and uses the identification information of said power provider as identification numbers “SSS” for the call number.

As an alternative to this, it is also possible, for example, for a preferred power provider (for example a provider of electric energy generated by regenerative methods) to be selected, said power provider having been interrogated by the vehicle driver via the user input device 25. In this case, the identification information of the preferred power provider is used as identification number “SSS”.

The identification numbers “NNN” for the grid operator arise inevitably from the electric energy distribution grid to which the electric car 13 is connected via the connection point 12d. In order to transfer this identification information to the electric car 13, it is possible, for example, for the connection point 12d to be equipped with an RFID chip 27, which is interrogated by the control device 22 via an RFID receiver 28.

The control device 22 which is used in the electric car 13 is constructed in such a way that it keeps the electric energy rating at a constant value at least when averaged over time. The identification number “LL” for the charging power is obtained from this value.

If a communication connection is set up at the same time as the transfer process, the communication service provider can, on the basis of the selected call number, make an assignment as to the power distribution grid from which the electric energy is drawn, the power provider which is to supply the electric energy, and the mean electric energy rating with which the electric energy storage device 20 will be charged.

By multiplying the period of time during which the communication connection is maintained (that is to say the period of time during which the transfer of power takes place) by the mean electric energy rating which is contained in the call number, it is possible to very easily determine the transferred electric energy. In a way analogous to the money collection procedures of value-added services, the driver of the vehicle pays the remuneration to the communication service provider, which then correspondingly passes it on to the grid operator and the power provider.

In summary, the control device 22 has, inter alia, the following properties and functions:

It has a man/machine interface in the form of the user input device 25 which can be used by the driver of the electric car 13 to input his requests with respect to the desired charge state of the electric energy storage device. These include, for example, the desired range, the expected time for which the electric car 13 is parked, and the price which is accepted for drawing the electric energy.

The control device 22 starts and ends the transfer of the electric energy in accordance with the communication connection produced via the communication device 23.

The control device 22 optionally retrieves power provider price information and decides which power provider electric energy will be obtained from.

The sequence during the charging of the electric energy storage device 20 of the electric car 13 is presented in summarized form below:

When the electric car 13 is parked, the vehicle driver specifies, via the user input device 25, the above-mentioned data relating to the charging target of the electric energy storage device 20 and, if appropriate, a preferred power provider.

After this, the communication device 23 firstly produces, by mobile radio, a connection to the data processing device 26 in order to determine the identification information or identification number “SSS” of a power provider. In this context, the control device 22 determines, if appropriate, the current power prices of the various power providers. In addition to the price information, the corresponding identification information or identification numbers “SSS” for the call number which are assigned to the individual power providers are transferred.

The control device 22 searches for a power provider on the basis of the user inputs (for example relating to the preferred power provider or a maximum acceptable price).

Furthermore, the control device 22 determines, on the basis of the user inputs of the vehicle driver and the current charge state of the electric energy storage device 20, a mean electric energy rating “LL” with which the charging process is to be carried out.

In addition, the control device 22 determines the identification information or identification number “NNN” which is assigned to the grid operator of the connection point 12d, and subsequently selects the corresponding call number by means of the communication device 23 using the individual identification numbers “LL”, “NNN” and “SSS”. As soon as the communication connection has come about, the communication device 23 outputs a start signal to the control device 22 and the transfer process is enabled. The control device 22 ensures that the electric energy with which the transfer is to take place is kept constant at least when averaged over time.

The transfer process is terminated at the same time as the communication connection is terminated. For this purpose, either the communication device 23 sends a signal to the control device 22 when the communication connection has been disconnected, or the control device 22 outputs, for example when a desired charge level of the electric energy storage device has been reached, a command to the communication device 23 to terminate the communication connection. When the communication device 23 confirms that the communication connection has been terminated, the control device 22 shuts off the transfer of the electric energy and therefore terminates the charging process.

The communication service provider 15 determines the duration of the communication connection and can therefore determine, by multiplication by the mean electric energy rating, the power which has been drawn from the electric grid. The communication service provider 15 is therefore able, on the one hand, to provide the vehicle driver with a bill for the costs for the electric energy and, on the other hand, to pay the power provider the remuneration for its services provided.

In summary, in the described method a communication infrastructure which is already present is advantageously utilized for measuring and billing for the electric energy which is transferred. It is not necessary to set up an additional infrastructure. The infrastructure for charging electric cars can therefore be extended very quickly in the area covered since the essential works comprise merely adapting the IT systems of the communication service providers. The connection points for the electric energy do not require separate communication and metering technology. The economic attractiveness of connection points for electric cars is therefore increased for grid operators. The proposed concept also involves minimum expenditure for the owner of an electric car. The owner merely has to enter into a contract with the communication service provider (for example a mobile radio contract). No economic relationships arise with other participants in the market.

Apart from the communication service provider, no other participant in the market obtains knowledge about the locations and immobilization times of the electric car. This is important from the point of view of data protection because in this way neither the grid operator nor the power provider can produce a movement profile of the electric car.

Although exclusively the drawing of electric energy from the power distribution grid by the electric car has been described in the exemplary embodiment described above, with the proposed method it is in principle also possible to bill for electric energy which is fed back into an electric energy distribution grid by an electric car, for example in order to even out load peaks. In this case, by means of the described method it is in turn possible to use the duration of the communication connection to determine the quantity of power which has been transferred into the power distribution grid from the electric energy storage device when there is a constant electric energy. Finally, the costs which the grid operator incurs as a result of the supplying of power can be derived from this, and these costs are credited to the vehicle driver by the communication service provider.

1-11. (canceled)

12. A method of controlling a transfer of electric energy between an electric energy storage device of a vehicle and a connection point of an electric power distribution grid, the method which comprises:
a) producing an electrical connection between the electric energy storage device of the vehicle and the connection point of the electric power distribution grid;
b) producing a communication connection between a communication device assigned to the vehicle and a communication service provider;
c) transferring the electric power between the electric energy storage device and the connection point during a period of time for which the communication connection exists, wherein a transfer of the electric energy takes place at a constant mean electric power; and
d) terminating the transfer of the electric energy and the communication connection substantially simultaneously.

13. The method according to claim 12, which comprises transferring via the communication connection a power information item indicating the mean electric power for the transfer of the electric power.

14. The method according to claim 13, which comprises determining the mean electric power using at least one of the following parameters:
a current charge state of the electric energy storage device;
a desired range of the vehicle;
a predefined time period during which the transfer of the electric power is to take place.

15. The method according to claim 12, which comprises determining, by the communication service provider, billing information at least from the period of time during which the communication connection is maintained and from the mean electric power for the transfer of the electric power, the billing information indicating a cost for the electric power thus transferred.

16. The method according to claim 12, which comprises, when the communication connection is produced, transferring identification information to the communication service provider, the identification information comprising an identifier of a grid operator of the power distribution grid and/or an identifier of a selected provider of electric power.

17. The method according to claim 16, which comprises setting up a mobile radio connection as a communication connection, and wherein the identification information and/or power information for indicating the mean electric power is contained in a call number used to produce the mobile radio connection.

18. The method according to claim 16, which comprises rendering available at the connection point for retrieval the identification information that comprises an identifier of the grid operator of the power distribution.

19. The method according to claim 16, which comprises, before the communication connection is produced by way of the communication device, retrieving the identification information that contains an identifier of the provider of the electric power from a data processing device that makes available identification information from various providers of electric power.

20. The method according to claim 19, which comprises, making available with the data processing device, in addition to the identification information for the individual providers of electric power, respective price information that indicates the prices of the electric power to be drawn, and selecting an identification information of the provider with a lowest price.

21. The method according to claim 12, which comprises:
communicating a start and an end of the communication connection by the communication device to a control device; and
permitting with the control device the electric power to be transferred exclusively for a period of time between the start and the end of the communication connection.

22. A device for controlling a transfer of electric power between an electric energy storage device of a vehicle and a connection point of an electric power supply grid, the device comprising:
a communication device configured to produce a communication connection with a communication service provider; and
a control device configured to permit a transfer of the electric power between the electric energy storage device and the connection point exclusively for a period of time during which the communication connection is maintained.
